(19) United States
(12) Patent Application Publication
(10) Pub. No.: US 2006/0244242 A1
(43) Pub. Date: Nov. 2, 2006

(54) Multifunctional bag structure

(76) Inventor: Wallace Woo, Ontario, CA (US)

Correspondence Address: TROXELL LAW OFFICE PLLC;ONE SKYLINE PLACE, SUITE 1404, 5205 LEESBURG PIKE, FALLS CHURCH, VA, 22041, US

(21) Appl. No.: 11/269,724

(22) Filed: Nov. 9, 2005

(30) Foreign Application Priority Data
Apr. 27, 2005 (CN) 200520016379.1

(51) Int. Cl. B62B 1/00; B62B 3/00

(52) U.S. Cl. 280/651

(57) ABSTRACT

A multifunctional bag structure includes a main bag which is a foldable bag structure and has a contractible strap disposed at the connection position of a front wall and two sidewalls for selectively fixing a rear fixing section corresponding to a rear wall or a front fixing section corresponding to a sidewall to fit a contracted or expanded form of the main bag. At least one fixed strap is fixed to an end of the rear wall, and at least a binding ring is disposed on another end. A cart has a wheel at both sides at the rear end of a support base, and two pulling rods are extended upward from the cart, and a handle is installed at the top of the pulling rod, so that the movable end of the fixed strap passes over the two pulling rods to another end of a binding ring and is folded in a reverse direction to connect the fixed strap. The main bag and the cart are integrated as a whole. The main bag can be combined selectively with a heating pad to form a heating bag or adds an additional bag on an external side for facilitating the playback of music.

### BACKGROUND OF THE INVENTION

1. Field of the Invention

The present invention relates to a multifunctional bag structure, and more particularly to a multifunctional bag structure being installed onto a cart or integrating an inner heat preserving bag into a main bag to define a heat preserving bag, and its external side could be connected to an additional bag for playing music.

2. Description of the Related Art

There are many occasions for us to carry things, and the ways of carrying things may vary, but it is unquestionable that using a bag to carry things or prevent things from falling out or being exposed is a common feasible way.

The commonest bag used for carrying or containing things is a shopping bag, and most shopping bags are designed in a foldable manner to give better accommodation and storage. However, it is quite difficult for shoppers to estimate the quantity of their shopping items, and thus a small bag cannot accommodate a large quantity of shopping items, and a large bag cannot flexibly adjust the interior space and the external look of the bag even though it can hold lots of things.

If the shopping bag is used to carry heavy items such as cans or bottles, the shopping bag is usually carried by hands or shoulders, not only creating a burden, but also hurting some part of our body. In view of this shortcoming, manufacturers try to overcome the shortcoming by integrating a box structure or a bag structure with a contractible cart to provide a portable traveling bag (carry-on bag) or a regular portable bag. The traveling box structure improves the structural strength between the box structure and the cart. In general, the box structure and the cart are designed in an inseparable or a difficult-to-remove manner, and the integration between the containing bag and the cart is achieved by using an elastically contractible tying means to tie the containing bag onto the cart and secure the bag. However, this method does not allow users to conveniently take out the things from the bag anytime. Furthermore, there is a pulling schoolbag, which can be separated or removed from the cart, but the integrated structure between the school bag and the cart is very complicated due to the should strap of the school bag. In general, the capacity of a schoolbag is limited to the interior containing space of the bag, and its interior space and external look cannot be flexibly adjusted according to the quantity of items contained therein. Therefore, finding a way to integrate the existing bag structure to give a multifunctional feature is a major subject for manufacturers.

### SUMMARY OF THE INVENTION

In view of the shortcomings of the prior art, the inventor of the present invention based on years of experience on the design and marketing of sports items and backpacks to conduct extensive researches and experiments and overcome the shortcomings of the prior art bag structure that can only provide a single function but cannot concurrently provide a multiple functions for shopping, traveling, pulling, heat preservation or recreation, etc, and finally invented the multifunctional bag structure in accordance with the present invention.

It is a primary objective of the present invention to provide a multifunctional bag structure comprising a main bag which is a foldable bag structure and has a contractible strap disposed at the connecting position of a front wall and two sidewalls for selectively fixing a rear fixing section corresponding to a rear wall or a front fixing section corresponding to a sidewall to fit a contracted or expanded form of the main bag. At least one fixed strap is fixed to an end of the rear wall, and at least a binding ring is disposed on another end. A cart has a wheel disposed separately on both sides of the rear end of a support base, and two pulling rods are extended upward from the cart, and a handle is installed at the top of the pulling rods, so that the movable end of the fixed strap passes over the two pulling rods to another end of a fastening ring and is folded in a reverse direction to connect the fixed strap. The main bag and the cart are integrated as a whole.

The secondary objective of the present invention is to provide a multifunctional bag structure, which further comprises an additional bag coupled to a switching means respectively corresponding to both sides of the main bag, and the additional bag has a built-in speaker separately installed on both sides of the front of the additional bag, and a signal line connects the two speakers, and the signal line extended from one of the speakers is connected to an output signal socket of a portable player, so that the two speakers can play sounds.

### BRIEF DESCRIPTION OF THE DRAWINGS

FIG. 1 is a perspective view of a main bag of the present invention;

FIG. 2 is a perspective view of a main bag being spread out according to the present invention;

FIG. 3 is a perspective view of a main bag being separated from a cart according to the present invention;

FIG. 4 is a perspective view of a main bag integrated with a cart according to the present invention;

FIG. 5 is a perspective view of a main bag, an inner bag and an additional bag being separated from each other according to the present invention; and

FIG. 6 is a perspective view of a multifunctional bag structure according to the present invention.

### DETAILED DESCRIPTION OF THE PREFERRED EMBODIMENTS

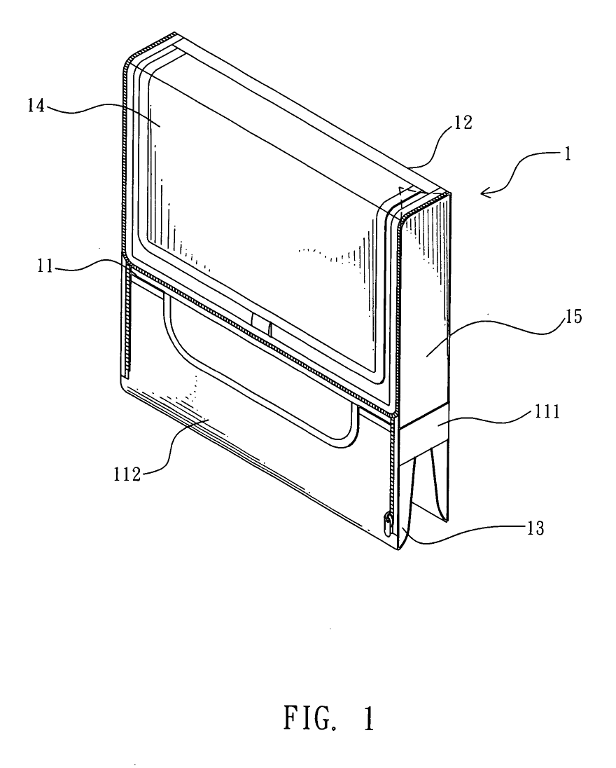

Referring to FIGS. 1 to 6, a multifimctional bag structure in accordance with the present invention comprises a main bag 1, a cart 2, an inner insulating bag 3 and an additional bag 4.

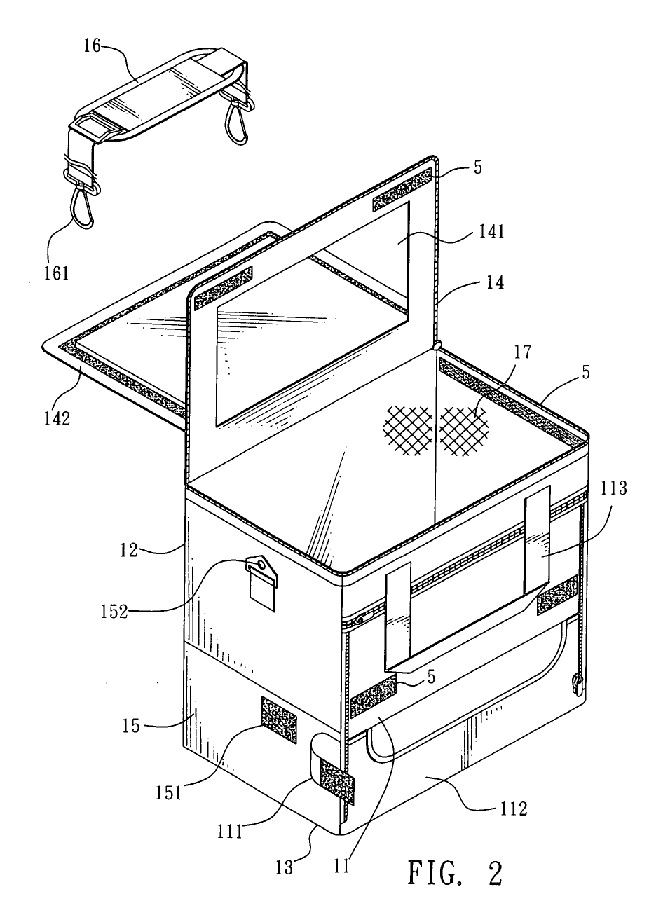

Referring to FIGS. 1 to 2, the main bag is a foldable bag structure and preferably rectangular in shape. The bag structure 1 comprises a front wall 11, a rear wall 12, a bottom 13, a top 14, and two sidewalls 15 to enclose and define a containing space. The technical characteristic of the present invention resides on that a contractible strap 111 is extended backward from the connecting position of the front wall 11 and the two sidewalls 15. If the strap 111 is connected to a rear fixing section 121 at a position corresponding to the rear wall 12, the two sidewalls and the bottom 12 of main bag 1 will be folded inward to greatly reduce the volume of the main bag 1. By then, the top 14 and the front wall 11 can be opened or closed for putting or taking out the things in the bag. The contractible strap 111 and the rear fixing section 121 are preferably fixed by adhesive tapes to achieve the stepless contractible effect, which is simply a prior art and thus will not be described here.

Referring to FIG. 2 for a schematic view of a main bag 1 being spread out to form a shopping bag, the contractible strap 111 and the rear fixing section 121 are separated and then the contractible strap 11 is connected to the front fixing section 151 on the sidewalls 15 for fixing the bag. A buckle 152 is installed at the middle section above the two sidewalls 15 for buckling a latch tool separately installed on both sides of an adjustable shoulder strap 16, so that the main bag 1 can be carried by shoulders. Further, the upper half of the front wall 11 and the rear wall 12 respectively has a handle strap 113, 122, so that the main bag 1 can be carried by hands. To improve the convenience of the use of the top 14, an opening 141 is built thereon and covered by an accessory cover 142. The periphery of the accessory cover 142 corresponds to that of the opening 142. A prior art switching means 5 such as an adhesive tape or a zipper is installed separately at the front and the periphery of an inner wall of the top 14 and the middle section of the front and the periphery of the top for opening and closing the bag. The top 14 is selectively connected to the front section of the front wall 11 or the top periphery of the switching means 5 according to a contracted or spread form, so as to cope with the change of volume and shape of the main bag 1. To achieve a heat preserving effect for the main bag 1, an insulating layer 17 is installed on the inner wall, and such arrangement is a prior art technology and thus will not be described here.

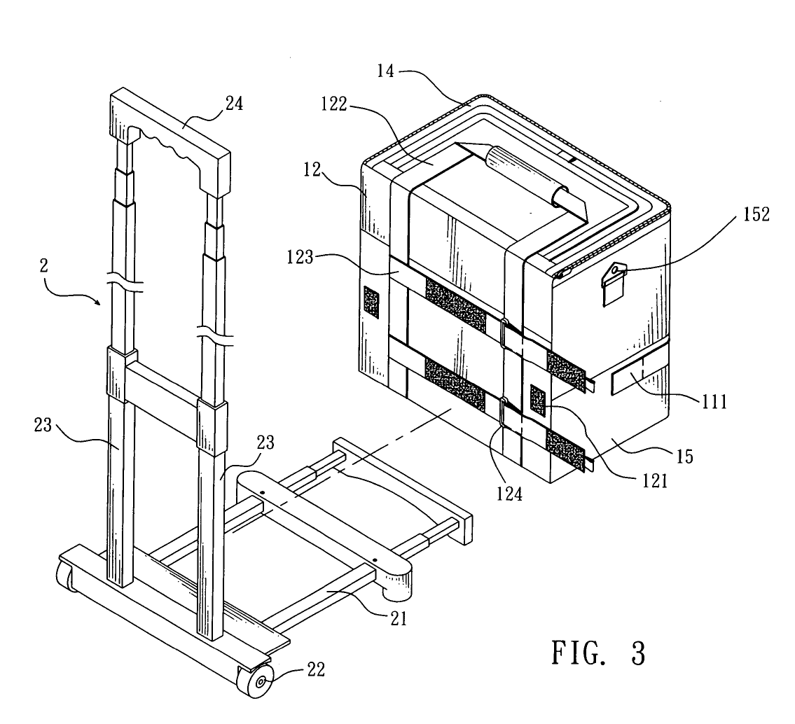

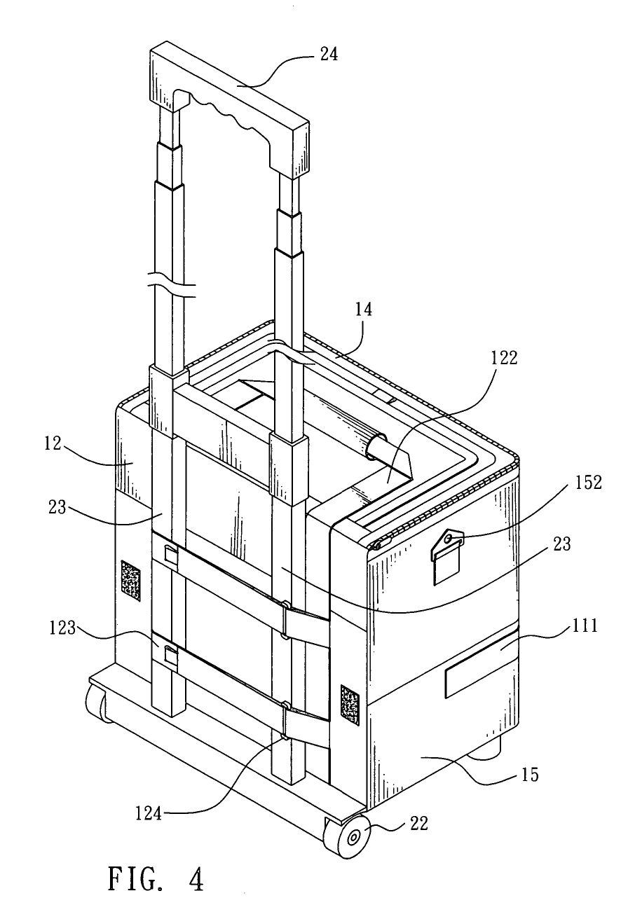

Referring to FIGS. 3 and 4, an integration of the main bag 1 and the cart 2 is illustrated. A wheel 22 is installed separately on both sides at the rear of a support base 21 of the cart 2, and two pulling rods 23 are extended from the cart 2. These pulling rods 23 are preferable contractible rods and have a handle at their top. During the assembly, the main bag 1 is placed on the top of the support base 21, and its rear wall 12 presses against the two pulling rods 23. By that time, a movable end of at least one fixing strap 123 installed at an end of the rear wall 12 is passed across the two pulling rods 23 and fixed to a pulling ring on the other end, and then the movable end is folded in a reverse direction to be connected to the fixing strap 123, so as to integrally combine the main bag 1 and the cart 2. The method for combining the two can be achieved by an adhesive tape or a buckle for achieving a fast and convenient assembly and separation.

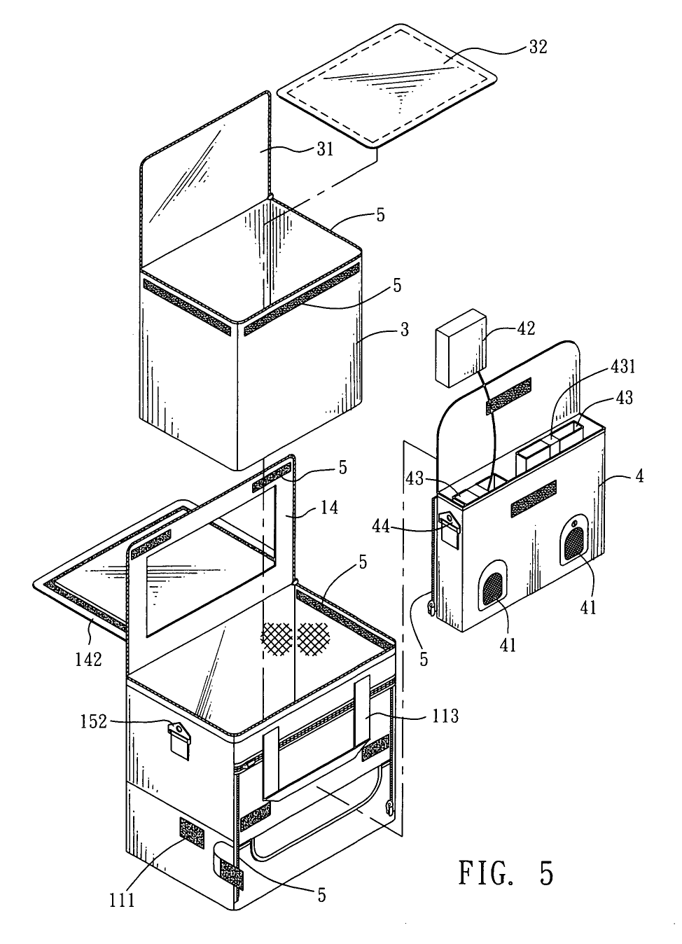

Referring to FIG. 5, the containing space of the main bag 1 can install another inner heat preserving bag 3 which is a multilayer bag made of a good insulating and waterproof material. The inner heat preserving bag 3 can be installed or separated by a switching means 5 between the periphery of the bag structure and the inner wall of the main bag 1. An upper lid 31 of the inner heat preserving bag 3 seals or opens the top of the bag structure by the switching means 5 to improve an overall rigidity, and a space 32 is installed inside the inner heat preserving bag 3.

The additional bag 4 is a bag for playing sounds such as music, and the inventor of the present invention has filed a patent application Ser. No. 10/826,306 to the USPTO on Apr. 29, 2004 for such invention, and such technology is adopted here for the additional bag 4. A built-in speaker 41 is installed separately on both sides of the front of the additional bag 4, and the two speakers 41 are connected by a signal line, and a signal line extended from one of the two speakers 41 is connected to a signal output socket of a portable player such as a CD player, a MP3 player, a MD player, a walkman, or a radio (not shown in the figure), so that sound can be played by the two speakers 41. In addition, the additional bag 4 has a power supply 42 installed therein, and the power supply 42 is a box structure preferably a dry cell for supplying power. A power supply line is connected to the speaker 41 for an amplifying function, wherein the power supply 2 and the portable player are installed in an inner bag 43 of the additional bag 4 and covered by a lid 431. The additional bag 4 and the main bag 1 are combined by the switch means 5 preferably a zipper on both corresponding sides, so that the two are securely combined and will not be fallen apart easily. The additional bag 4 could install a buckle 44 separately on both sides of its top, so that the additional bag 4 can be carried by the shoulder strap 6 on its own.

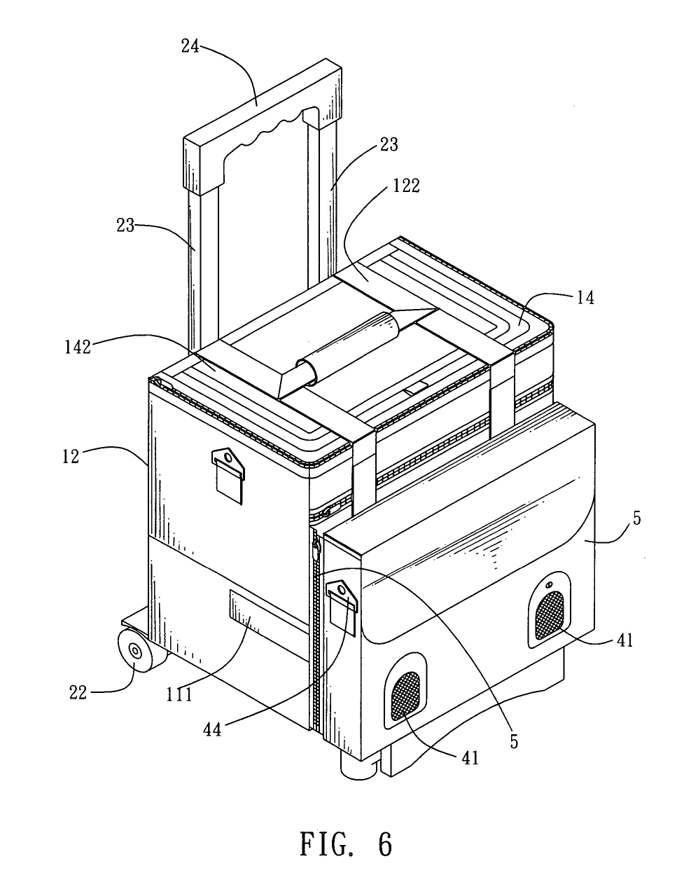

Referring to FIG. 6 for the space configuration after each of the components as disclosed above is installed, the heat preserving bag 3 can store cold drinks for outdoor activities. By combining the main bag 1 with the cart 2, it is easy to transport the bag without any trouble, and the additional bag 4 can play music to give more fun and recreations to users. The bag structure of the present invention definitely demonstrates a different multifunctional feature.

In summation of the above description, the present invention herein complies with the patent application requirements and is submitted for patent application. However, the description and its accompanied drawings are used for describing preferred embodiments of the present invention, and it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A multifunctional bag structure, comprising:
a main bag, being a foldable bag, and having a contractible strap extended from a connecting position of a front wall and two sidewalls, and selectively fixed to a rear fixing section disposed at a position corresponding to a rear wall or a front fixing section of said sidewalls, for producing a contracted or spread out form, and at least one fixing strap being disposed at an end of said rear wall, and at least one fastening ring being disposed on another corresponding end; and
a cart, having a wheel separately installed on both ends of a rear side of a support base, two pulling rods extended upward from said cart, and a handle installed at the top of said pulling rods;
thereby, said fixing strap is passed across said two pulling rods to a said fastening ring on the other end and then folded in a reverse direction to fix said strap, and said main bag and said cart is integrally combined.

2. The multifunctional bag structure of claim 1, wherein said contractible strap, said rear fixing section and said front fixing section are adhesive tapes.

3. The multifunctional bag structure of claim 1, wherein said main bag includes at least one layered bag disposed at said front wall.

4. The multifimctional bag structure of claim 1, wherein said main bag includes a buckle disposed at the top of said two sidewalls for buckling a latch means disposed on both ends of an adjustable shoulder strap, and a handle strap disposed at the upper half of said front wall and rear wall of said main bag.

5. The multifunctional bag structure of claim 1, wherein said main bag includes an opening at said top covered by an accessory cover, and said accessory cover corresponds to the periphery of said opening, and a switch means is installed separately at the front side and periphery of said top and the middle section and top periphery of said front wall.

6. The multifunctional bag structure of claim 1, wherein said top of said main bag is contracted or spread according to said main bag and selectively coupled to said switch means at the front middle section of said front wall or the top periphery.

7. The multifunctional bag structure of claim 1 further comprising:
an inner heat preserving bag, being a multilayered bag opened or closed by a switch means disposed between the periphery of said bag structure and the inner wall of said main bag, and the top of said heat preserving base also has a switch means for sealing or opening said top.

8. The multifunctional bag structure of claim 7, wherein said inner heat preserving bag includes a spacer disposed therein.

9. The multifunctional bag structure of claim 1, further comprising:
an additional bag, coupled with a switch means corresponding to both sides of said main bag and installing a built-in speaker separately on both sides of the front of said additional bag, and a signal input line connected between said two speakers and a signal input line being extended from one of said two speakers to connect with a signal output socket of a portable player for producing sound from said two speakers.

10. The multifunctional bag structure of claim 9, wherein said portable player is a CD player, a MP3 player, a MD player, a walkman or a radio.

11. The multifunctional bag structure of claim 9, wherein said additional bag includes a power supply device being a box structure and connected to said speaker by a power supply line.

12. The multifunctional bag structure of claims 9 or 11, wherein said power supply device and said portable player are disposed in an inner layered bag of said additional bag and covered by a lid.

13. The multiftunctional bag structure of claim 9, wherein said additional bag includes a bucket at the top of both side of aid additional bag for connecting a latch means on both sides of an adjustable shoulder strap.
